(19) United States
(12) Patent Application Publication
(10) Pub. No.: US 2024/0079921 A1
(43) Pub. Date: Mar. 7, 2024

(54) MOTOR GENERATOR

(71) Applicant: FINEMECH Co., Ltd., Yokohama-shi (JP)

(72) Inventor: Kazuyoshi HIRAIWA, Yokohama-shi (JP)

(73) Assignee: FINEMECH Co., Ltd., Yokohama-shi (JP)

(21) Appl. No.: 17/902,302

(22) Filed: Sep. 2, 2022

(51) Int. Cl. H02K 1/2783; B60L 50/51; H02K 21/14; H02K 21/22

(52) U.S. Cl. CPC H02K 1/2783; B60L 50/51; H02K 21/14; H02K 21/227

(57) ABSTRACT

High efficiency and reduction of loss at high rotation speed can be attained with a simple configuration. The M/G includes a disc-shaped rotor 12 coupled to a main shaft 10 rotatably supported by a housing 20, 22. The rotor 12 has a permanent magnet array 14 providing a Halbach array magnetic field. Armature coils 16 are arranged in a disc-shape array to oppose to the permanent magnet array 14 and fixed to the housing 20, 22 as stators. A disc-shaped magnetic field member 24 is made of a magnetic material and arranged in a recessed part 22c formed in the housing 20, 22 at a side of the armature coils 16 opposite to the permanent magnet array 14.

### BACKGROUND OF THE INVENTION

### Field of the Invention

The present invention relates to a motor generator (hereinafter described as M/G) used in an electric car for example, required to have big output with small size, and/or required to have variable output.

### DESCRIPTION OF THE RELATED ART

An M/G providing big output with small size is described for example in Patent Document 1 as an electromagnetic device such as a rotary electrical machine. This electromagnetic device uses permanent magnet arrays referred to as the Halbach arrays. Particularly, the second embodiment (FIG. 10) in Patent Document 1 describes an electromagnetic device and a rotary electrical machine, which may provide the output equal to that of the M/G with the dual Halbach arrays at high rotation speed even though it has the single Halbach array. This is because the second embodiment device has a cylindrical shaped stator 64 made of magnetic materials is provided.

Also, in an axial gap type M/G capable of changing its output, it is known an M/G provided with a variable distance air gap between the permanent magnets and the armature coils (described for example in Patent Document 2). This M/G can suppress increase in the voltage induced in the armature coils at high rotation speed to reduce the power loss.

However, because the M/G using the conventional permanent magnet array with the Halbach array described in the second embodiment of Patent Document 1 has only one set of the field system unit (permanent magnet array) 66 and the coils 20, it is impossible to improve performance of the M/G by providing the dual Halbach arrays having two sets of the field system units and the coils. Also, since such conventional M/G is not able to change the distance of the air gap, it is difficult to reduce the power loss at high rotation speed.

On the other hand, since the conventional axial gap type M/G described in Patent Document 2 is necessary to shift the rotors in the axial direction for changing the distance of the air gaps, the structure of the M/G becomes complicated.

### RELATED ART DOCUMENTS

Patent Document 1: US 2020/0244119 A1
Patent Document 2: US 2012/0146445 A1

### SUMMARY OF THE INVENTION

The problem to be solved according to the present invention is that the conventional M/G has low applicability for enhancing its performance by for example adopting the dual Halbach array structure or reducing the loss in high rotation speed, or that the conventional M/G becomes complicated in structure to achieve them.

It is therefore an object of the present invention to provide an M/G, with simple constitution, capable of enhancing its applicability to provide high output in comparison with its size and capable of changing the output.

According to the present invention, an M/G includes a disc-shaped rotor coupled to a main shaft rotatably supported by a housing, the rotor having a permanent magnet array providing a Halbach array magnetic field, a plurality of armature coils arranged in a disc-shape array to oppose to the permanent magnet array and fixed to the housing as stators, and a disc-shaped magnetic field member made of a magnetic material and arranged in a recessed part formed in the housing at a side of the armature coils opposite to the permanent magnet array.

It is preferred that the M/G includes two sets of the permanent magnet arrays, two sets of the armature coils and two sets of the magnetic field member.

It is also preferred that the magnetic field member is capable of axially moving from a position adjacent to the armature coils to a position far from the armature coils.

It is further preferred that the M/G further includes a spring arranged between the magnetic field member and the housing, for pressing the magnetic field member in a direction approaching to the armature coils.

It is still further preferred that the magnetic field member is configured to axially move with rotation thereof.

It is further preferred that the M/G further includes a support member arranged between the armature coils and the magnetic field member. The support member is integral with the armature coils and made of a magnetic material.

### Effect of the Invention

According to the M/G of the present invention, it will be possible to provide a high output power by making in a so-called axial type arrangement. Also, it will be possible to provide advantages of a variable air gap type arrangement with a simple configuration, that is, reduction of the power loss at high rotation speed.

### BRIEF DESCRIPTION OF THE DRAWINGS

FIG. 1 is a sectional view of a main part of an M/G in a first embodiment according to the present invention;

FIG. 2 is an A-A sectional view of armature coils shown in FIG. 1;

FIG. 3 is a front view showing the shape of a first permanent magnet array in the first embodiment;

FIG. 4 is an external development view showing the arrangement of the first permanent magnet array in the first embodiment;

FIG. 5 is a partial external view of a second housing in the first embodiment;

FIG. 6 is a sectional view of a main part of an M/G in a second embodiment according to the present invention;

FIG. 7 is a sectional view of a main part of an M/G in a third embodiment according to the present invention; and

FIG. 8 is a sectional view of a main part of an M/G in a fourth embodiment according to the present invention.

### DETAILED DESCRIPTION OF THE INVENTION

Hereinafter, an M/G 1 according to the present invention will be described based on first to fourth embodiments with reference to the attached drawings.

### First Embodiment

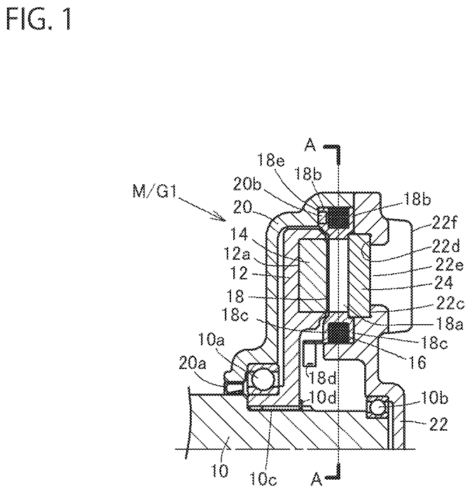

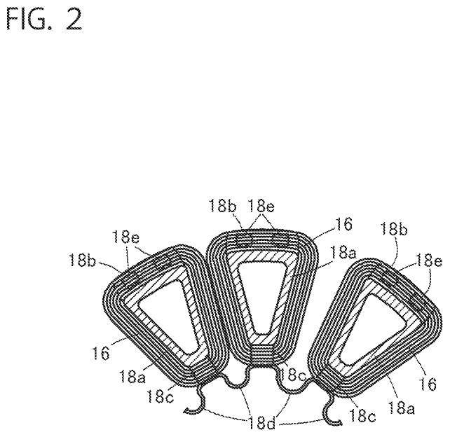

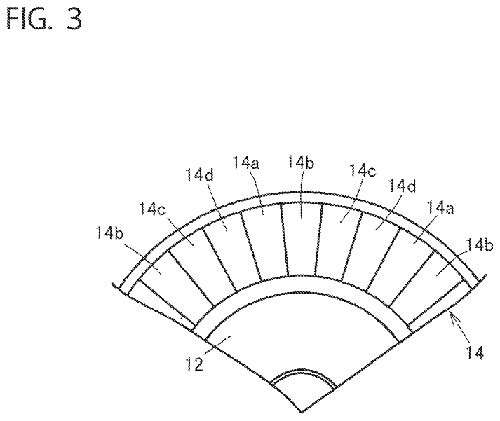

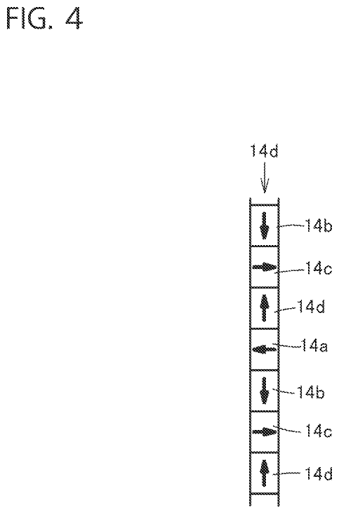

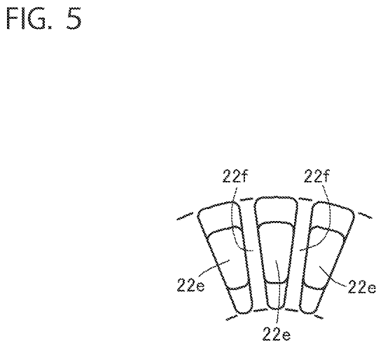

FIG. 1 a sectional view showing upper half part of a main part of the M/G 1 in the first embodiment according to the present invention. FIG. 2 is a sectional view along A-A line of FIG. 1 showing the shape of armature coils 16. This FIG. 2 shows about quarter of circumference of the M/G 1. FIG. 3 is a front view of a part of a permanent magnet array 14 of a rotor 12, seen from and matched against the armature coils 16 of FIG. 2. FIG. 4 is a development view of the arrangement of permanent magnets 14a to 14d of the permanent magnet array 14, seen from the outside of the diametrical direction of FIG. 3. FIG. 5 is a partial external view of a second housing 22 seen from the right side of FIG. 1.

In this first embodiment, the main shaft 10 of the M/G 1 and also the rotor 12 that corresponds to the rotor according to the present invention are rotatably supported by a first housing 20 and the second housing 22 through first bearings 10a and second bearings 10b. An oil seal 20a is inserted between the first housing 20 and the main shaft 10. The disc-shaped rotor 12 is coupled with the main shaft 10 in the rotating direction by a spline 10c and axially fixed to the main shaft 10 by a snap ring 10d.

The rotor 12 has a recessed part 12a in the side facing the armature coils 16, and the permanent magnet array 14 is fitted in this recessed part 12a. A main part of the rotor 12 is preferably made of austenitic stainless steel or titanium that are nonmagnetic materials. The permanent magnet array 14 is fixed in the recessed part 12a by using an adhesive or press-fitted in the recessed part 12a.

The permanent magnet array 14 is constituted by 32 permanent magnets of four kinds of permanent magnets 14a to 14d as shown in FIG. 3. This permanent magnet array 14 forms a so-called Halbach array in which four kinds of permanent magnets are alternately arranged so that the directions of N poles are different with each other. Here, as shown in FIG. 4, N pole and S pole of each of the permanent magnets 14a to 14d are represented by arrows and arrowheads thereof indicate N poles.

The 12 armature coils 16 arranged in disc shape and faced against the rotor 12 correspond to a stator of the present invention. These armature coils 16 are wound around bobbins 18 and held and fixed between the first housing 20 and the second housing 22 through the bobbins 18. The armature coils 16 are air-core coils with no magnetic material core and preferably use a Ritz line. These armature coils 16 are electrically connected to a power supply not shown as well-known three-phase coils.

The bobbins 18 are made of non-magnetic material such as Bakelite. As shown in FIG. 1 and FIG. 2, 12 cores 18a of the bobbins 18 have 12 outer flanges 18b and 12 inner flanges 18c on both axial direction sides, respectively. The 12 cores 18a are connected with each other by a joint member 18d at one side of the 12 inner flanges 18c. Because the joint member 18d has flexibility, it is possible to keep the adjacent cores 18a away to each other by deforming the joint member 18d as shown in the right side of FIG. 2. Therefore, the armature coils 16 are preferably wound around the bobbins 18 in the state shown in the right side of FIG. 2, and the bobbins 18 and the armature coils 16 are assembled with the first housing 20 in the state shown in the left side of FIG. 2.

Each of the 12 bobbins 18 has two recesses 18e formed on one side of the outer flange 18b. The first housing 20 has projections 20b at positions corresponding to the recesses 18e. By engaging the recesses 18e with the projections 20b, the bobbins 18 or the armature coils 16 are fixed to the first housing 20 and thus the torque produced at the bobbins 18 (stator) acts on the first housing 20. It should be noted that the fixing method of the bobbins 18 to the first housing 20 may be reversed. Namely, recesses may be formed in the first housing 20 and the projections may be formed on the bobbins 18. Instead of the bobbins 18 around which the armature coils 16 are wound, holders that grasp the armature cores 16 from the outside for surrounding and contacting the armature coils 16 may be formed.

The second housing 22 has a recessed part 22c formed in the axial right side of the armature coils 16, and a disc-shaped magnetic field member 24 made of a magnetic material is fitted in and fixed to this recessed part 22c. The recessed part 22c has at its axial bottom 22d a plurality of through holes 22e. A plurality of fins 22f are formed at both sides of each through hole 22e along circumferential direction as shown in FIG. 5. The through holes 22e and the fins 22f are formed in shapes and dimensions in consideration of cooling of the magnet field member 24 and of strength and rigidity of the second housing 22.

In the above-mentioned configuration of the first embodiment, the M/G has the 32 permanent magnets 14a to 14d. However, in modification, the M/G may have 64 permanent magnets and 24 armature coils 16. Also, in further modification, the M/G of single Halbach array may have permanent magnets of the number of kinds that is different from the first embodiment as described in Patent Document 1.

Now, functions and operations of the M/G 1 according to the first embodiment will be described. The M/G 1 has both functions of using as a motor for rotating the main shaft 10 by supplying electricity to the armature coils 16 and of using as a generator for taking out electricity from the armature coils 16 by driving the main shaft 10 using outside power. In the application of utilizing the M/G 1 in an electric car or a hybrid car, the functions of the motor and the functions of generator will be appropriately switched.

As discussed above in detail, the M/G 1 according to this first embodiment can generate and provide strong Halbach array magnetic field in the region of the armature coils 16 side of the permanent magnet array 14 due to the existence of the magnetic field member 24 in both cases of the motor and the generator. Thus, it is possible to provide big mechanical power to the main shaft 10 and to receive big electrical power from the main shaft 10 for considering its size even in case that the axial direction length is limited.

### Second Embodiment

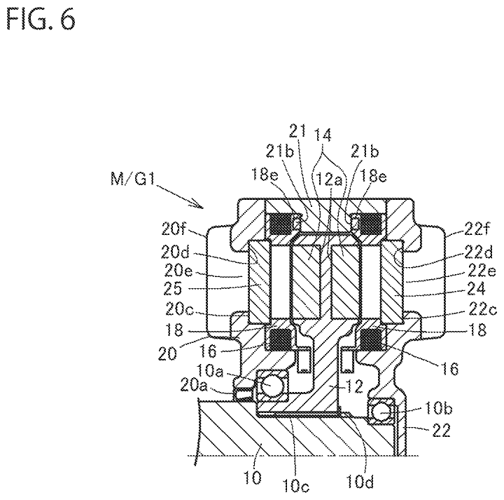

FIG. 6 is a sectional view showing upper half part of a main part of the M/G 1 in a second embodiment according to the present invention. Hereinafter, described are mainly components different from these of the first embodiment. The components substantially the same as these of the first embodiment will be referred using the same reference numerals and the explanation thereof will be omitted.

The M/G 1 of the second embodiment differs from that of the first embodiment in the following points. The M/G 1 of this second embodiment has two permanent magnet arrays 14 and two sets of armature coils 16, and has a first magnetic field member 24 and a second magnetic field member 25 corresponding to these arrays and the coils, respectively. More concretely, in this second embodiment, the rotor 12 corresponding to the rotor according to the present invention has the permanent magnet arrays 14 axially aligned with respect to the main shaft 10, and the armature coils 16, the first magnetic field member 24 and the second magnetic field member 25 corresponding to the stator according to the present invention are arranged symmetrically on both sides of the rotor 12 in the axial direction of the main shaft 10.

An intermediate housing 21 is assembled between the first housing 20 and the second housing 22. Two bobbins 18 are fixed between the first housing 20 and the intermediate housing 21 and between the second housing 22 and the intermediate housing 21, respectively. The second magnetic field member 25 is fitted in a recessed part 20c formed in the first housing 20. The first housing 20 has an axial bottom 20d, a plurality of through holes 20e and a plurality of fins 20f formed similar to these of the second housing 22. Other configurations of the M/G 1 in this second embodiment are basically similar to those of the M/G 1 in the first embodiment, and therefore explanation thereof is omitted.

Now, functions and operations of the M/G 1 according to the second embodiment will be described. The two permanent magnet arrays 14 and the two sets of armature coils 16 of the M/G 1 have both functions of a motor and a generator and operate as well as that described in the first embodiment, respectively.

As discussed above in detail, because the M/G 1 according to this second embodiment has the two permanent magnet arrays 14 and the two sets of armature coils 16, it is possible to provide substantially two times mechanical power to the main shaft 10 and to receive substantially two times electrical power from the main shaft 10. That is, the M/G 1 can provide big mechanical power equal to that of the quad Halbach arrays to the main shaft 10 and can receive big electrical power equal to that of the quad Halbach arrays from the main shaft 10 for considering its size of general dual Halbach arrays.

### Third Embodiment

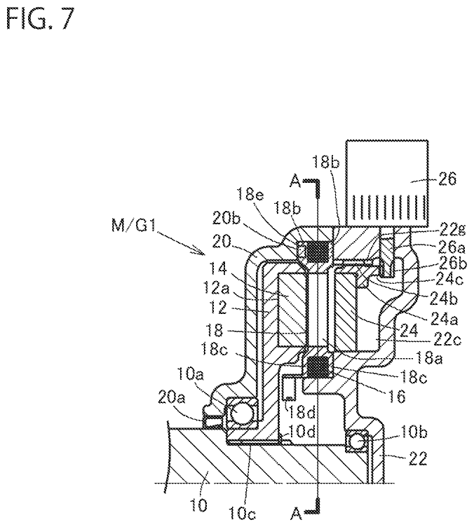

FIG. 7 is a sectional view showing upper half part of a main part of the M/G 1 in a third embodiment according to the present invention. Hereinafter, described are mainly components different from these of the first and second embodiments. The components substantially the same as these of the first and second embodiments will be referred using the same reference numerals and the explanation thereof will be omitted.

The M/G 1 of the third embodiment differs from the M/G 1 of the first embodiment in the following points. In the M/G 1 of this third embodiment, the magnetic field member 24 is possible to axially move within a recessed part 22c formed in the second housing 22. More concretely, in this third embodiment, a screw thread 24b is formed on a surface of a holder 24a integrated with the magnetic field member 24, which surface is opposed to the second housing 22, and a screw thread 22g is formed on a surface of the second housing 22, which surface is opposed to the holder 24a. These screw threads 24b and 22g are engaged with each other. A gear 26b formed on a rotation shaft 26a of an actuator attached to the second housing 22 is engaged with a gear thread 24c formed on the holder 24a. When the rotation shaft 26a is rotated by the actuator 26, the holder 24a is rotated around the axial center of the main shaft 10. Thus, the magnetic field member 24 and the holder 24a move in the axial direction of the main shaft 10 due to the operations of the screw thread 24b and the screw thread 22g engaged with each other.

It is preferable that the screw thread 24b and the screw thread 22g are configured by triple thread screws. By configuring the triple thread screws, it is possible to prevent inclination of the engagement between the second housing 22 and the holder 24a. The gear 26b formed on the rotation shaft 26a is engaged with a gear thread 24c formed on a helical surface of the holder 24a. The gear thread 24c formed on the holder 24a has the same lead as that of the screw thread 24b. Thus, if the magnetic field member 24 and the holder 24a rotate and axially move, relationship of engagement of the gear thread 24c and the gear 26b will be basically kept without change.

Although the M/G 1 according to this third embodiment has other components such as a power supply and controller for controlling the actuator 26 and sensors for detecting an axial direction position and a rotating direction position of the magnetic field member 24, illustrations thereof in the drawings are omitted. Because other configurations of the M/G 1 according to the third embodiment are basically similar to that of the first embodiment, explanations thereof are also omitted.

Now, functions and operations of the M/G 1 according to the third embodiment will be described. The two permanent magnet arrays 14 and the two sets of armature coils 16 of the M/G 1 have both functions of a motor and a generator and operate as well as that described in the first embodiment, respectively. In addition, since the M/G 1 according to this third embodiment is capable of axially moving the magnetic field member 24 within the recessed part 22c, the input/output characteristics of the M/G 1 will be changed depending upon the axial position of the magnetic field member 24.

That is, because the magnetic field formed between the permanent magnet array 14 and the armature coils 16 changes depending upon a position of the magnetic field member 24, the input/output characteristics of the M/G 1 becomes a level obtained by the dual Halbach arrays when the magnetic field member 24 is located at the nearest position to the armature coils 16 as discussed in the first embodiment. Whereas the input/output characteristics of the M/G 1 changes to a level obtained by the single Halbach array when the magnetic field member 24 moves to go away from the armature coils 16.

In other words, the power capable of inputting to or outputting from the M/G 1 may change in a range of a ratio of approximately 1 to 2 depending upon the position of the magnetic field member 24. Namely, when the magnetic field member 24 is located far from the armature coils 16, the power of the M/G 1 will be equal to that of the single Halbach array. Whereas when the magnetic field member 24 is located near the armature coils 16, the power of the M/G 1 will be equal to that of the dual Halbach array that is twice of the single Halbach array. This is because the magnetic flux from the permanent magnet arrays 14 crossing the armature coils 16 changes depending upon the position of the magnetic field member 24. Particularly, the induced voltage in the high rotation speed will be suppressed when the magnetic field member 24 is at the position far away from the armature coils 16.

As afore mentioned, the M/G 1 of the third embodiment has advantages of capable of controlling the input/output power in a range of a ratio of approximately 1 to 2 depending upon the axial position of the magnetic field member 24. The characteristics is suitable for machines such as automobiles in which the fluctuation width of the load in driving or braking is quite large. If a big driving torque is needed at a low rotation speed, the machines may be driven by the power equal to a level obtained by the dual Halbach arrays, whereas if the driving load is relatively low at a high rotation speed, the machines may be driven by the induced voltage equal to a level obtained by the single Halbach array to reduce the power loss.

The M/G 1 according to this third embodiment can provide these characteristics only by moving the magnetic field member 24 that is not main components of the M/G 1, such as the rotor or the stator. As a result, it is possible to provide an M/G with a simple constitution, a low manufacturing cost and a right weight in comparison with the conventional M/G described in Patent Document 2, which can also reduce the induced voltage.

### Fourth Embodiment

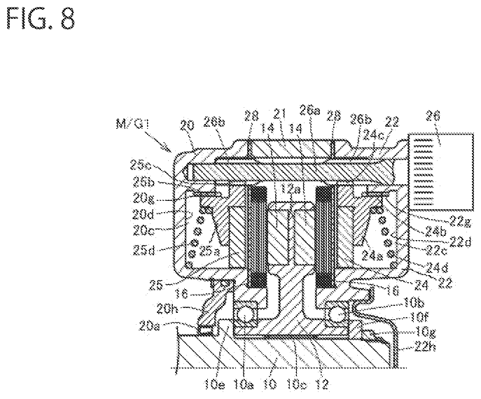

FIG. 8 is a sectional view showing upper half part of a main part of the M/G 1 in a fourth embodiment according to the present invention. Hereinafter, described are mainly components different from these of the first to third embodiments. The components substantially the same as these of the first to third embodiments will be referred using the same reference numerals and the explanation thereof will be omitted.

The M/G 1 of the fourth embodiment has a constitution formed by combining the M/G 1 of the second embodiment and the M/G 1 of the third embodiment. That is, this M/G 1 of the fourth embodiment has two permanent magnet arrays 14, two armature coils 16, a first magnetic field member 24 and a second magnetic field member 25 respectively corresponding to these, as well as two of the M/G 1 of the second embodiment. Also, the first magnetic field member 24 and the second magnetic field member 25 of this M/G 1 of the fourth embodiment are configured to axially move as well as the M/G 1 of the third embodiment.

The armature coils 16 in the M/G 1 of the fourth embodiment are not wound around bobbins 18 as done in the M/G 1 of the first to third embodiments, but integrated with support members 28 made of magnetic steel sheets and fixed to the first housing 20, the intermediate housing 21 and the second housing 22. In other words, the support members 28 are arranged between the armature coils 16 and the first magnetic field member 24, and between the armature coils 16 and the second magnetic field member 25, respectively.

Also, the M/G 1 of the fourth embodiment differs from the M/G 1 of the third embodiment in a configuration for coupling the actuator 26 so as to axially move both the first magnetic field member 24 and the second magnetic field member 25. That is, the first magnetic field member 24 and the second magnetic field member 25 are integrated with a first holder 24a and a second holder 25a, respectively, a screw thread 24b is formed on a surface of the first holder 24a, which surface is opposed to the second housing 22, and a screw thread 22g is formed on a surface of the second housing 22, which surface is opposed to the first holder 24a. These screw threads 24b and 22g are engaged with each other. A screw thread 25b is formed on a surface of the second holder 25a, which surface is opposed to the first housing 20, and a screw thread 20g is formed on a surface of the first housing 20, which surface is opposed to the second holder 25a. These screw threads 25b and 20g are engaged with each other. A gear 26b formed on a rotation shaft 26a of the actuator attached to the second housing 22 is engaged with a gear thread 24c formed on the first holder 24a and with a gear thread 25c formed on the second holder 25a.

When the rotation shaft 26a of the actuator 26 is rotated, the first holder 24a and the second holder 25a are rotated around the axial center of the main shaft 10. Thus, the first magnetic field member 24 and the first holder 24a move in the axial direction of the main shaft 10 due to the operations of the screw thread 24b and the screw thread 22g engaged with each other, and the second magnetic field member 25 and the second holder 25a move in the axial direction of the main shaft 10 due to the operations of the screw thread 25b and the screw thread 20g engaged with each other. It should be noted that the twisting direction of the screw thread 24b and the screw thread 22g is reverse with respect to the twisting direction of the screw thread 25b and the screw thread 20g so that the first magnetic field member 24 and the second magnetic field member 25 axially move to the opposite direction with each other when they are rotated or screwed in the same direction. Thus, when the actuator 26 rotates in one direction, the first magnetic field member 24 and the second magnetic field member 25 move toward the side adjacent to the armature coils 16, and when the actuator 26 rotates in the opposite direction, the first magnetic field member 24 and the second magnetic field member 25 move toward the side far from the armature coils 16.

The M/G 1 of the fourth embodiment has springs 24d and 25d between the first holder 24a and a bottom 22d of a recessed part 22c and between the second holder 25a and a bottom 20d of a recessed part 20c, respectively. Preferably, the springs 24d and 25d are configured by conical coil springs. By the spring 24d and 25d, the first magnetic field member 24 and the second magnetic field member 25 are always pressed in the direction approaching to the armature coils 16, respectively. Thus, when moving the first magnetic field member 24 and the second magnetic field member 25 toward the side far from the armature coils 16, the actuator 26 drives its rotation axis 26a against the pressing force of the springs 24d and 25d. Whereas, when moving the first magnetic field member 24 and the second magnetic field member 25 toward the side adjacent to the armature coils 16, the actuator 26 drives the rotation axis 26a with the assistant of the pressing force of the springs 24d and 25d.

The M/G 1 of the fourth embodiment differs from the M/G 1 of the first to third embodiment in a fixing configuration for axially fixing first bearing 10a and second bearing 10b that are adopted to support the main shaft 10, to the first housing 20 and the second housing 22, respectively. That is, the first housing 20 and the second housing 22 are tightened in the direction mutually closing to each other by a nut 10g through a thrust washer 10f. An oil seal 20a is supported by the first housing 20 through a cover 20h, and a cover 22h is attached to the second housing 22.

Now, functions and operations of the M/G 1 according to the fourth embodiment will be described. The M/G 1 according to this fourth embodiment has both functions of a motor and a generator as well as that described in the first embodiment. In addition, as aforementioned, since the M/G 1 according to this embodiment has the two permanent magnet arrays 14 and the two sets of armature coils 16, the first magnetic field member 24 and the second field magnetic member 25 corresponding to them, it is possible to provide big mechanical power equal to that of the quad Halbach arrays to the main shaft 10 and to receive big electrical power equal to that of the quad Halbach arrays from the main shaft 10, as well as that described in the second embodiment. Also, since the M/G 1 according to this fourth embodiment is capable of axially moving the first magnetic field member 24 and the second magnetic field member 25, the input/output characteristics of the motor and the generator will be changed depending upon the axial position of the magnetic field member 24 and the second magnetic field member 25, as well as that described in the third embodiment.

In other words, the M/G 1 according to this fourth embodiment can provide the input/output characteristics of a level obtained by the quad Halbach arrays when the first magnetic field member 24 and the second magnetic field member 25 are located at the nearest position to the armature coils 16, and the input/output characteristics of the M/G 1 changes to a level obtained by the dual Halbach array when the first magnetic field member 24 and the second magnetic field member 25 move to go away from the armature coils 16.

The springs 24d and 25d arranged between the first magnetic field member 24 and the second magnetic field member 25 and the bottoms 22d and 20d act to perform quick movement in a direction making the first magnetic field member 24 and the second magnetic field member 25 approach the armature coils 16, and also act to perform slightly slow movement in a direction making the first magnetic field member 24 and the second magnetic field member 25 far away from the armature coils 16.

As afore mentioned, the M/G 1 of the fourth embodiment has advantages of capable of providing a power equal to a level obtained by the quad Halbach arrays if a big driving torque is needed at a low rotation speed, and advantages of capable of being driven by an induced voltage equal to a level obtained by the dual Halbach array to reduce the power loss if the driving load is relatively low at a high rotation speed.

Furthermore, the M/G 1 of the fourth embodiment can provide quick change of the input/output characteristics owing to the operations of the springs 24d and 25d. In general, it may be requested to quickly increase the input/output characteristics of the M/G 1.

The M/G 1 according to the fourth embodiment can provide these characteristics only by moving the magnetic field member 24 and the second magnetic field member 25 that are not main components of the M/G 1, such as the rotor or the stator. As a result, it is possible to provide an M/G with a simple constitution, a low manufacturing cost and a right weight in comparison with the conventional M/G described in Patent Document 2, which can also reduce the induced voltage.

As for concrete applications, the present invention may be utilized in a so-called series type hybrid system. In the hybrid system. Two M/GS according to the present invention are used, one M/G is coupled to an internal combustion engine so as to generate electrical power, and the other M/G is coupled to wheels so as to control and drive them. Also, the present invention may be utilized in an M/G with unstable operating conditions, such as an M/G of a drone or a wind power generator. This is because the M/G according to the present invention can easily change its input/output power depending upon the position of the magnetic field member.

Many widely different embodiments of the present invention may be constructed without departing from the spirit and scope of the present invention. It should be understood that the present invention is not limited to the specific embodiments described in the specification, except as defined in the appended claims.

### INDUSTRIAL APPLICABILITY

The M/G according to the present invention can be widely used in various applications that are required high efficiency in a small size, such as an electric car and a hybrid car. Particularly, the M/G according to the present invention can be used in applications with large variations in the load.

1. A motor generator comprising:
a disc-shaped rotor coupled to a main shaft supported by a housing, said rotor having a permanent magnet array providing a Halbach array magnetic field;
a plurality of armature coils arranged in a disc-shape array to oppose to said permanent magnet array and fixed to said housing as stators; and
a disc-shaped magnetic field member made of a magnetic material and arranged in a recessed part formed in said housing at a side of said armature coils opposite to said permanent magnet array.

2. The motor generator as claimed in claim 1, wherein said motor generator includes two sets of said permanent magnet arrays, two sets of said armature coils and two sets of said magnetic field member.

3. The motor generator as claimed in claim 1, wherein said magnetic field member is capable of axially moving from a position adjacent to said armature coils to a position far from said armature coils.

4. The motor generator as claimed in claim 3, wherein said motor generator further comprises a spring arranged between said magnetic field member and said housing, for pressing said magnetic field member in a direction approaching to said armature coils.

5. The motor generator as claimed in claim 3, wherein said magnetic field member is configured to axially move with rotation thereof.

6. The motor generator as claimed in claim 1, wherein said motor generator further comprises a support member arranged between said armature coils and said magnetic field member, said support member being integral with said armature coils and made of a magnetic material.
